(19) United States
(12) Patent Application Publication
(10) Pub. No.: US 2024/0217601 A1
(43) Pub. Date: Jul. 4, 2024

(54) LIFTING CART APPARATUS FOR VEHICLE BODY COMPONENTS

(71) Applicant: Jose Guzman, Denton, TX (US)

(72) Inventor: Jose Guzman, Denton, TX (US)

(21) Appl. No.: 18/090,845

(22) Filed: Dec. 29, 2022

(51) Int. Cl. B62D 65/02; B66F 7/12; B66F 7/26; B66F 7/28

(52) U.S. Cl. CPC B62D 65/022; B62D 65/026; B66F 7/12; B66F 7/26; B66F 7/28

(57) ABSTRACT

A lifting cart apparatus for engaging and moving a vehicle body component includes a wheeled base frame with a lift for raising and lowering a support platform relative to the base frame. The support platform has a pair of support arms for supporting a vehicle body component. A stabilizer is coupled to the support platform for engagingly stabilizing the vehicle body component on the support platform.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to lifting cart apparatuses and more particularly pertains to a new lifting cart apparatus for engaging and moving a vehicle body component.

### (2) Description of Related Art Including Information Disclosed Under 37 CFR 1.97 and 1.98

The prior art relates to myriad lifting cart apparatuses which use a variety of means for attaching to a vehicle body component such as clamps, support surfaces, and suction cups. These apparatuses also employ a variety of lifting and positioning means such as jacks, hydraulic lifts, and levers.

### BRIEF SUMMARY OF THE INVENTION

An embodiment of the disclosure meets the needs presented above by generally comprising a base frame, a plurality of wheels is coupled to and extending downwardly from the base frame, and a lift coupled. The lift is positioned on a top side of the base frame and is extendable upwardly away from the base frame. A support platform is coupled to the lift such that the support platform is movable by the lift between a lowered position and a raised position with respect to the base frame. The lift is retracted to position the support platform in the lowered position and is extended to position the support platform in the raised position. The lift is coupled to a lower side of the support platform. The support platform comprises a pair of support arms positioned laterally from each other. Each support arm has an upper surface configured for supporting the vehicle body component thereon. A stabilizer is coupled to the support platform which is configured for engagingly stabilizing the vehicle body component on the support platform.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a lifting cart apparatus according to an embodiment of the disclosure.

FIG. 2 is a front view of an embodiment of the disclosure.

FIG. 3 is a top rear side perspective view of an embodiment of the disclosure.

FIG. 4 is a side view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

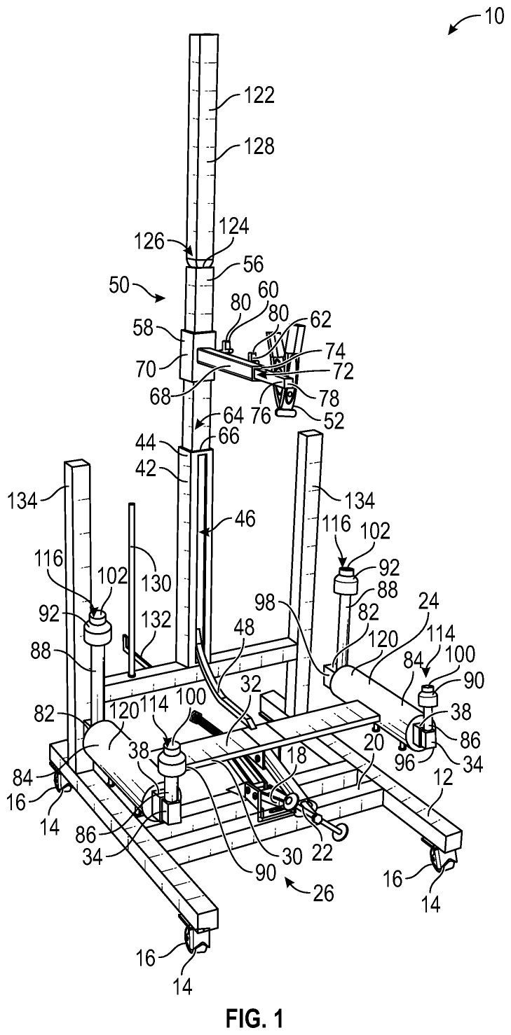

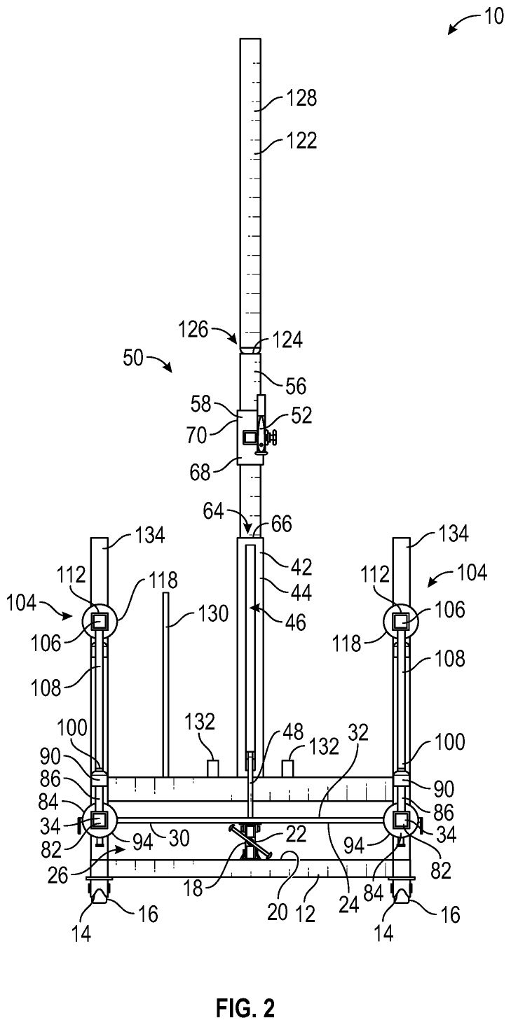

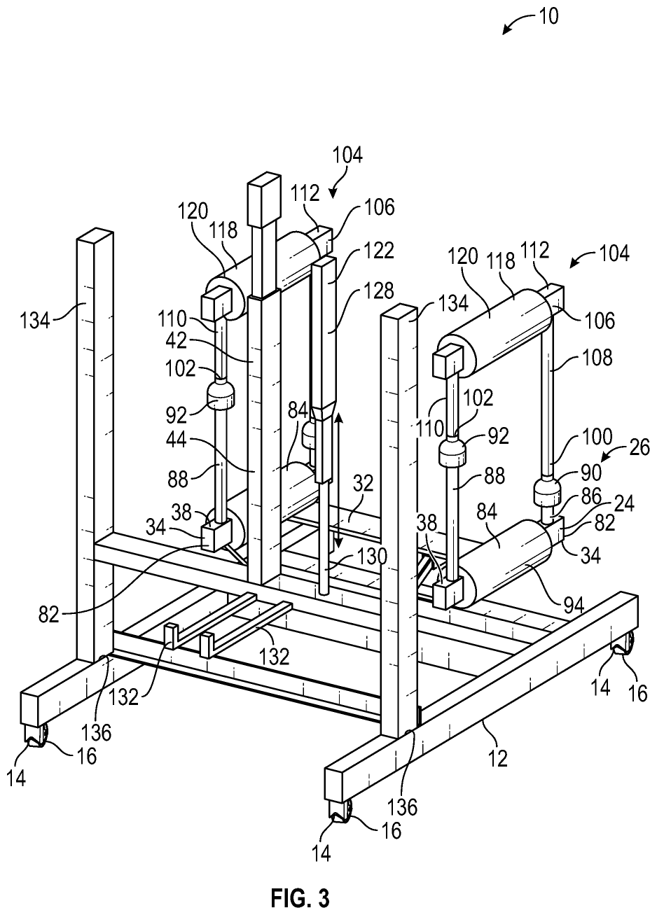

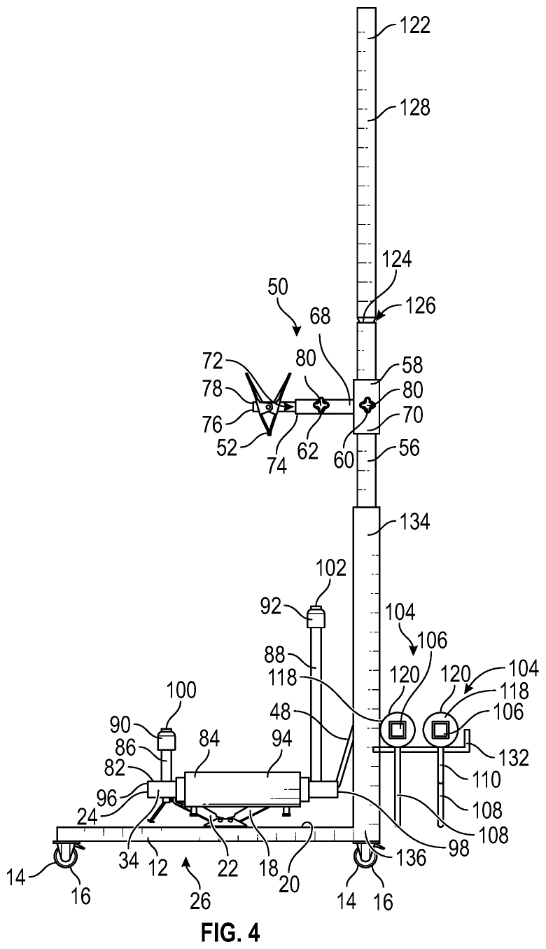

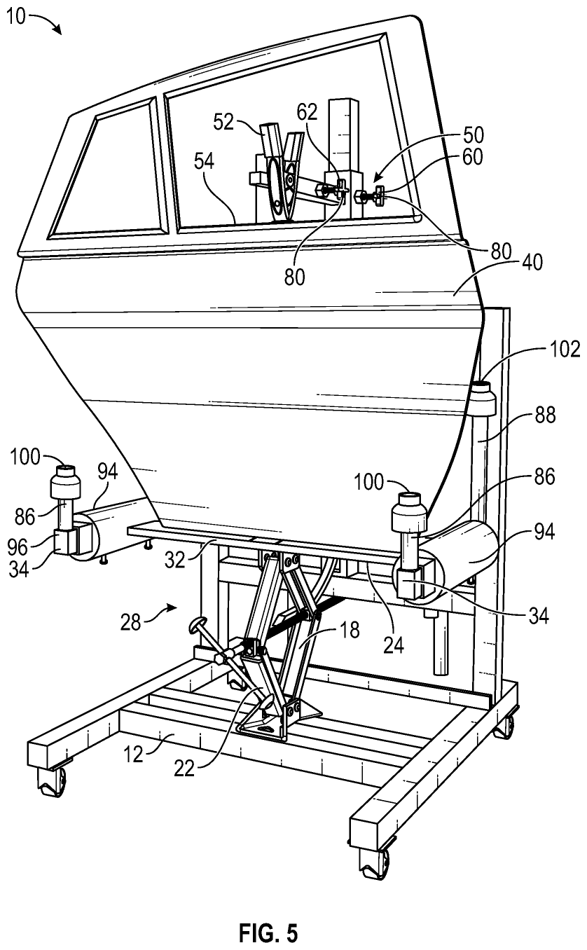

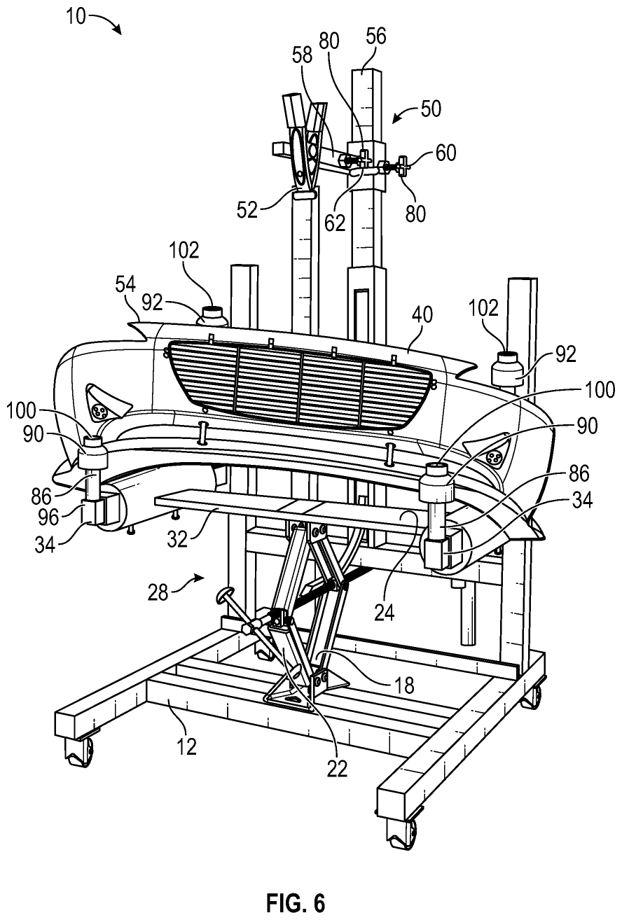

With reference now to the drawings, and in particular to FIGS. 1 through 6 thereof, a new lifting cart apparatus embodying the principles and concepts of an embodiment of the disclosure and generally designated by the reference numeral 10 will be described.

As best illustrated in FIGS. 1 through 6, the lifting cart apparatus 10 generally comprises a base frame 12. A plurality of wheels 14 is coupled to and extends downwardly from the base frame 12, and each one of the plurality of wheels 14 is a caster wheel 16. A lift 18 is coupled to the base frame 12 and is positioned on a top side 20 of the base frame 12. The lift 18 is extendable upwardly away from the base frame 12, and the lift 18 comprises a jack 22. A support platform 24 is coupled to the lift 18 such that the support platform 24 is movable by the lift 18 between a lowered position 26 and a raised position 28 with respect to the base frame 12. The lift 18 is retracted to position the support platform 24 in the lowered position 26 and is extended to position the support platform 24 in the raised position 28. The lift 18 is coupled to a lower side 30 of the support platform 24. The support platform 24 comprises a central member 32 and a pair of support arms 34, the central member 32 being positioned between the support arms 34. Each of the pair of support arms 34 has an upper surface 38 configured for supporting a vehicle body component 40 thereon.

A platform guide 42 is coupled to the base frame 12 and engages the support platform 24 to maintain the support platform 24 on a vertical path between the lowered position 26 and the raised position 28. The platform guide 42 comprises a track 44 which is coupled to and extends upwardly from the base frame 12. The track 44 is elongated and has a slot 46 extending upwardly from the base frame 12. The track 44 is positioned rearwardly of the central member 32 of the support platform 24. The support platform 24 comprises a guide bar 48 which is coupled to and extends rearwardly from the central member 32. The guide bar 48 is slidably coupled to the track 44 such that the guide bar 48 is movable along the track 44. The guide bar 48 extends into the slot 46.

A stabilizer 50 is coupled to the support platform 24 and comprises a clamp 52 that is configured to releasably couple to a top portion 54 of the vehicle body component 40 when the support platform 24 is supporting the vehicle body component 40. The stabilizer 50 further comprises a column 56, a positioning arm 58, a first fastener 60, and a second fastener 62. The column 56 is coupled to and extends upwardly from the guide bar 48 of the support platform 24 and is slidably coupled to the track 44. The track 44 has a channel 64 positioned therein and extending through a top end 66 of the track 44, and the column 56 extends out of the top end 66. The positioning arm 58 is vertically slidably coupled to the column 56. The positioning arm 58 is extendable forwardly away from the column 56. The positioning arm 58 comprises a base arm 68 which has a sleeve 70 that slidably receives the column 56 therethrough. The base arm 68 extends forwardly from the column 56 and has an opening 72 extending through a distal end 74 of the base arm 68 with respect to the column 56. The positioning arm 58 also comprises a slide arm 76 that is telescopically engaged with the base arm 68, with the slide arm 76 being received through the opening 72. The clamp 52 is coupled to the slide arm 76 adjacent to a free end 78 of the slide arm 76. The first fastener 60 releasably statically couples the base arm 68 to the column 56 and the second fastener 62 releasably statically couples the base arm 68 to the slide arm 76. The first 60 and second 62 fasteners are setscrews 80 which are each threadably coupled to the base arm 68 and which releasably engage the column 56 and the slide arm 76 respectively.

Each support arm 34 of the pair of support arms 34 comprises an elongated support 82, a support buffer 84, a front support post 86, a rear support post 88, a front protector 90, and a rear protector 92. The elongated support 82 extends forwardly and rearwardly with respect to the base frame 12. The support buffer 84 is coupled to and laterally surrounds the elongated support 82 and is configured for preventing damage to the vehicle body component 40 due to contact with the upper surface 38 of the support arm 34. The support buffer 84 comprises a resiliently compressible material and has a smooth outer surface 84. The front support post 86 is coupled to and extends upwardly from the elongated support 82. The front support post 86 is positioned adjacent to a front side 96 of the support platform 24. The rear support post 88 is coupled to and extends upwardly from the elongated support 82. The rear support post 88 is positioned adjacent to a rear side 98 of the support platform 24. The rear support post 34 extends farther from the elongated support 82 than the front support post 86.

The front protector 90 is coupled to the front support post 86 adjacent to an upper end 100 of the front support post 86. The rear protector 92 is coupled to the rear support post 88 adjacent to an upper end 102 of the rear support post 88. Each of the front 90 and rear 92 protectors is shock absorbing to prevent damage to the vehicle body component 40 due to impact between the vehicle body component 40 and either of the front 90 and rear 92 protectors. Each of the front 90 and rear 92 protectors also comprises an elastomeric material.

Each of a pair of platform extenders 104 is releasably coupled to the front support post 86 and the rear support post 88 of one of the pair of support arms 34. Each platform extender 104 comprises an extension support 106, a front extension post 108, and a rear extension post 110. The extension support 106 is elongated and extends forwardly and rearwardly with respect to the base frame 12. The platform extender 104 has a topmost support surface 112 configured for supporting the vehicle body component 40. The front extension post 108 is coupled to and extends downwardly from the extension support 106 adjacent to a front end of the extension support 106. The front extension post 108 is releasably coupled to the front support post 86. The front support post 86 has a recess 114 extending into the upper end 100 thereof for receiving the front extension post 108. A rear extension post 110 is coupled to and extends downwardly from the extension support 106 adjacent to a rear end of the extension support 106. The rear extension post 110 is releasably coupled to the rear support post 88. The rear support post 88 has a recess 116 extending into the upper end 102 thereof for receiving the rear extension post 110. Each platform extender 104 may also comprise an extension buffer 118 configured for preventing damage to the vehicle body component 40 due to contact with the topmost support surface 112 of the platform extender 104. The extension buffer 118 is coupled to and laterally surrounds the platform extender 104. The extension buffer 118 comprises a resiliently compressible material and has a smooth outer surface 120.

An extension post 122 is releasably couplable to an uppermost end 124 of the column 56 of the stabilizer 50 such that the positioning arm 58 can slide upwardly onto the extension post 122. The column 56 has a hole 126 extending through the uppermost end 124 such that the extension post 122 can be received therethrough. The extension post 122 may have a tubular shape 128 and an elongated post holder 130 may be coupled to the base frame 12 for storing the extension post 122. In such an embodiment, the elongated post holder 130 extends upwardly from the base frame 12 and has a size such that the extension post 122 can receive the elongated post holder 130 therethrough for mounting the extension post 122 for storage. At least one extender hook 132 may be coupled to the base frame 12 to store each of the platform extenders 104. In this case, each extender hook 132 extends rearwardly and upwardly from the base frame 12. A pair of handles 134 may also be included for grabbing and positioning the base frame 12. Each one of the pair of handles 134 may, for example, be coupled to and extend upwardly from laterally opposed rear corners 136 of the base frame 12.

In use, the platform is positioned under the vehicle body component 40 by adjusting the position of the base frame 12 along a floor surface and extending or retracting the lift 18. The clamp 52 of the stabilizer 50 is positioned to engage the top portion 54 of the vehicle body component 40 by sliding the base frame 12 of the positioning arm 58 vertically on the column 56 and moving the slide arm 76 toward and away from the column 56. The base arm 68 and the slide arm 76 are fastened in place, and the clamp 52 is actuated to engage the top portion 54. The vehicle body component 40 may then be repositioned as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lifting cart apparatus for selectively engaging and moving a vehicle body component, the lifting cart apparatus comprising:
a base frame;
a plurality of wheels being coupled to and extending downwardly from the base frame;
a lift being coupled to the base frame, the lift being positioned on a top side of the base frame, the lift being extendable upwardly away from the base frame;
a support platform being coupled to the lift such that the support platform is movable by the lift between a lowered position and a raised position with respect to the base frame, the lift being retracted to position the lift in the lowered position, the lift being extended to position the lift in the raised position, the lift being coupled to a lower side of the support platform, the support platform comprising a pair of support arms, each of the pair of support arms being positioned laterally from each other, each of the pair of support arms having an upper surface configured for supporting the vehicle body component thereon; and
a stabilizer being coupled to the support platform and being configured for engagingly stabilizing the vehicle body component on the support platform, the stabilizer comprising.

2. The apparatus of claim 1, wherein the stabilizer comprises a clamp being configured to releasably couple to a top portion of the vehicle body component when the support platform is supporting the vehicle body component.

3. The apparatus of claim 1, wherein each of the plurality of wheels is a caster wheel.

4. The apparatus of claim 1, wherein the lift comprises a jack.

5. The apparatus of claim 1, further comprising a platform guide being coupled to the base frame and engaging the support platform to maintain the support platform on a vertical path between the lowered position and the raised position.

6. The apparatus of claim 5, wherein the platform guide comprises a track being coupled to and extending upwardly from the base frame, the track being elongated, the track being positioned rearwardly of the support platform, the support platform comprising a guide bar, the guide bar being coupled to and extending rearwardly from the support platform, the guide bar being slidably coupled to the track such that the guide bar is movable along the track.

7. The apparatus of claim 6, wherein the track has a slot extending upwardly from the base frame, the guide bar extending into the slot.

8. The apparatus of claim 1, wherein the stabilizer comprises:
a column being coupled to and extending upwardly from the support platform;
a positioning arm being vertically slidably coupled to the column, the positioning arm being extendable forwardly away from the column, the clamp being coupled to the positioning arm;
a first fastener releasably statically coupling the base arm to the column; and
a second fastener releasably statically coupling the base arm to the slide arm.

9. The apparatus of claim 8, wherein the positioning arm comprises:
a base arm having a sleeve slidably receiving the column therethrough, the base arm extending forwardly from the column, the base arm having an opening extending through a distal end of the base arm with respect to the column; and
a slide arm being telescopically engaged with the base arm, the slide arm being received through the opening, the clamp being coupled to the slide arm adjacent to a free end of the slide arm.

10. The apparatus of claim 9, wherein the stabilizer further comprises a first fastener releasably statically coupling the base arm to the column and a second fastener releasably statically coupling the base arm to the slide arm.

11. The apparatus of claim 6, wherein the stabilizer comprises:
a column being coupled to and extending upwardly from the guide bar of the support platform, the column being slidably coupled to the track, the track having a channel positioned therein and extending through a top end of the track, the column extending out of the top end;
a positioning arm being vertically slidably coupled to the column, the positioning arm being extendable forwardly away from the column, the positioning arm comprising:
a base arm having a sleeve slidably receiving the column therethrough, the base arm extending forwardly from the column, the base arm having an opening extending through a distal end of the base arm with respect to the column; and
a slide arm being telescopically engaged with the base arm, the slide arm being received through the opening;
the clamp being coupled to the slide arm adjacent to a free end of the slide arm;
a first fastener releasably statically coupling the base arm to the column; and
a second fastener releasably statically coupling the base arm to the slide arm.

12. The apparatus of claim 1, wherein each support arm of the pair of support arms comprises:
an elongated support extending forwardly and rearwardly with respect to the base frame; and
a support buffer being coupled to and laterally surrounding the elongated support and being configured for preventing damage to the vehicle body component due to contact with the upper surface of the support arm, the support buffer comprising a resiliently compressible material, the support buffer having a smooth outer surface.

13. The apparatus of claim 12, further comprising:
each support arm further comprising:
a front support post being coupled to and extending upwardly from the elongated support, the front support post being positioned adjacent to a front side of the support platform; and
a rear support post being coupled to and extending upwardly from the elongated support, the rear support post being positioned adjacent to a rear side of the support platform, the rear support post extending farther from the elongated support than the front support post; and
a pair of platform extenders, each platform extender of the pair of platform extenders being releasably coupled to the front support post and the rear support post of one of the pair of support arms, each platform extender comprising an extension support being elongated and extending forwardly and rearwardly with respect to the base frame, the platform extender having a topmost support surface configured for supporting the vehicle body component.

14. The apparatus of claim 13, wherein each platform extender further comprises:
a front extension post being coupled to and extending downwardly from the extension support, the front extension post being positioned adjacent to a front end of the extension support, the front extension post being releasably coupled to the front support post, the front support post having a recess extending into an upper end thereof for receiving the front extension post; and
a rear extension post being coupled to and extending downwardly from the extension support, the rear extension post being positioned adjacent to a rear end of the extension support, the rear extension post being releasably coupled to the rear support post, the rear support post having a recess extending into an upper end thereof for receiving the rear extension post.

15. The apparatus of claim 13, wherein each platform extender further comprises an extension buffer configured for preventing damage to the vehicle body component due to contact with the topmost support surface of the platform extender, the extension buffer being coupled to and laterally surrounding the platform extender, the extension buffer comprising a resiliently compressible material, the extension buffer having a smooth outer surface.

16. The apparatus of claim 13, wherein each support arm further comprises:
a front protector being coupled to the front support post, the front protector being shock absorbing such that the front protector is configured to prevent damage to the vehicle body component due to impact between the vehicle body component and the front protector, the front protector being positioned adjacent to the upper end of the front support post, the front protector comprising an elastomeric material; and
a rear protector being coupled to the rear support post, the rear protector being shock absorbing such that the rear protector is configured to prevent damage to the vehicle body component due to impact between the vehicle body component and the rear protector, the rear protector being positioned adjacent to the upper end of the rear support post, the rear protector comprising an elastomeric material.

17. A lifting cart apparatus for selectively engaging and moving a vehicle body component, the lifting cart apparatus comprising:
a base frame;
a plurality of wheels being coupled to and extending downwardly from the base frame, each one of the plurality of wheels being a caster wheel;
a lift being coupled to the base frame, the lift being positioned on a top side of the base frame, the lift being extendable upwardly away from the base frame, the lift comprising a jack;
a support platform being coupled to the lift such that the support platform is movable by the lift between a lowered position and a raised position with respect to the base frame, the lift being retracted to position the lift in the lowered position, the lift being extended to position the lift in the raised position, the lift being coupled to a lower side of the support platform, the support platform comprising a central member and a pair of support arms, the central member being positioned between the support, each of the pair of support arms having an upper surface for supporting the vehicle body component thereon;
a platform guide being coupled to the base frame and engaging the support platform to maintain the support platform on a vertical path between the lowered position and the raised position, the platform guide comprising a track being coupled to and extending upwardly from the base frame, the track being elongated, the track having a slot extending upwardly from the base frame, the track being positioned rearwardly of the central member of the support platform, the support platform including a guide bar, the guide bar being coupled to and extending rearwardly from the central member, the guide bar being slidably coupled to the track such that the guide bar is movable along the track, the guide bar extending into the slot;
a stabilizer being coupled to the support platform and being configured for engagingly stabilizing the vehicle body component on the support platform, the stabilizer comprising a clamp being configured to releasably couple to a top portion of the vehicle body component when the support platform is supporting the vehicle body component, the stabilizer comprising:
a column being coupled to and extending upwardly from the guide bar of the support platform, the column being slidably coupled to the track, the track having a channel positioned therein and extending through a top end of the track, the column extending out of the top end;
a positioning arm being vertically slidably coupled to the column, the positioning arm being extendable forwardly away from the column, the positioning arm comprising:
a base arm having a sleeve slidably receiving the column therethrough, the base arm extending forwardly from the column, the base arm having an opening extending through a distal end of the base arm with respect to the column; and
a slide arm being telescopically engaged with the base arm, the slide arm being received through the opening;
the clamp being coupled to the slide arm adjacent to a free end of the slide arm;
a first fastener releasably statically coupling the base arm to the column; and
a second fastener releasably statically coupling the base arm to the slide arm;
each support arm of the pair of support arms comprising:
an elongated support extending forwardly and rearwardly with respect to the base frame;
a support buffer being coupled to and laterally surrounding the elongated support and being configured for preventing damage to the vehicle body component due to contact with the upper surface of the support arm, the support buffer comprising a resiliently compressible material, the support buffer having a smooth outer surface;
a front support post being coupled to and extending upwardly from the elongated support, the front support post being positioned adjacent to a front side of the support platform;
a rear support post being coupled to and extending upwardly from the elongated support, the rear support post being positioned adjacent to a rear side of the support platform, the rear support post extending farther from the elongated support than the front support post;
a front protector being coupled to the front support post, the front protector being shock absorbing such that the front protector is configured to prevent damage to the vehicle body component due to impact between the vehicle body component and the front protector, the front protector being positioned adjacent to the upper end of the front support post, the front protector comprising an elastomeric material; and
a rear protector being coupled to the rear support post, the rear protector being shock absorbing such that the rear protector is configured to prevent damage to the vehicle body component due to impact between the vehicle body component and the rear protector, the rear protector being positioned adjacent to the upper end of the rear support post, the rear protector comprising an elastomeric material; and
a pair of platform extenders, each platform extender of the pair of platform extenders being releasably coupled to the front support post and the rear support post of one of the pair of support arms, each platform extender comprising:
an extension support being elongated and extending forwardly and rearwardly with respect to the base frame, the platform extender having a topmost support surface configured for supporting the vehicle body component;
a front extension post being coupled to and extending downwardly from the extension support, the front extension post being positioned adjacent to a front end of the extension support, the front extension post being releasably coupled to the front support post, the front support post having a recess extending into an upper end thereof for receiving the front extension post;
a rear extension post being coupled to and extending downwardly from the extension support, the rear extension post being positioned adjacent to a rear end of the extension support, the rear extension post being releasably coupled to the rear support post, the rear support post having a recess extending into an upper end thereof for receiving the rear extension post; and
an extension buffer configured for preventing damage component to the vehicle body due to contact with the topmost support surface of the platform extender, the extension buffer being coupled to and laterally surrounding the platform extender, the extension buffer comprising a resiliently compressible material, the extension buffer having a smooth outer surface.
